(19) United States
(12) Patent Application Publication
(10) Pub. No.: US 2021/0297976 A1
(43) Pub. Date: Sep. 23, 2021

(54) MAINTAINING VALIDITY OF TIMING ADVANCE

(71) Applicant: TELEFONAKTIEBOLAGET LM ERICSSON (PUBL), Stockholm (SE)

(72) Inventors: Gerardo Agni MEDINA ACOSTA, MÄRSTA (SE); Olof LIBERG, Enskede (SE); Yutao SUI, SOLNA (SE); Hazhir SHOKRI RAZAGHI, SOLNA (SE)

(21) Appl. No.: 17/263,807

(22) PCT Filed: Aug. 2, 2019
(86) PCT No.: PCT/IB2019/056611

§ 371 Date: Jan. 27, 2021

Related U.S. Application Data
(60) Provisional application No. 62/716,752, filed on Aug. 9, 2018.

(51) Int. Cl. H04W 56/00

(52) U.S. Cl. CPC H04W 56/0045; H04W 56/003

(57) ABSTRACT

Systems and methods are provided for maintaining validity of a timing advance value in a wireless device operable in a wireless communication network. According to an embodiment, validity of a previously configured a TA value in a wireless device is determined by comparing the previously configured TA value to a threshold. The threshold may be based on an amount of time required for a radio signal to traverse a distance corresponding to the intended radius of a cell serving the wireless device. Alternatively, the TA validity may be determined based on a history of TA updates. Optionally, a previously configured TA value may be gradually ramped up or down until the wireless device receives an acknowledgment of successful receipt of an UL data transmission by the base station.

### TECHNICAL FIELD

The present disclosure relates, in general, to communication networks and, more particularly, to maintaining validity of timing advance values used by certain wireless devices in communications networks.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

eNodeB in an Evolved Universal Terrestrial Radio Access (E-UTRA) wireless communication system uses a timing advance (TA) command or message to instruct UEs (also referred to herein as wireless devices) to adjust their transmit timing, which allows for a similar arrival time of uplink (UL) transmission of UEs located at different distances to the eNodeB. This is very important, because if the UL arrival times are not aligned properly, the transmissions from different UEs are no longer orthogonal and interfere with each other and, consequently, the uplink system performance may be significantly degraded.

An initial timing advance command is included in a random access response, where a timing advance field or parameter (T_{A}) can be any value from 0 to 1282 as indicated by an 11-bit timing advance command. The amount of time alignment is given by multiplying T_{A} by 16, resulting in a TA value (N_{TA}). The TA value, N_{TA}, is defined in 3GPP Technical Specification 36.211 as the “Timing offset between uplink and downlink radio frames at the UE, expressed in units of Ts.” On this matter, Ts is the basic time unit defined as Ts=1/(15000×2048) seconds.

Thus, the step size of the amount of time alignment is given in multiples of 16Ts, where 1 step T_{A} is equal to 16Ts=0.52 μs. Moreover, the step size T_{A} can be obtained in terms of distance if we use the speed of light (which is around 300 000 000 m/s) as a reference, and we divide the resulting distance by a factor of 2 (this because the T_{A} is a round trip measurement). Based on the above, 1 step T_{A} is around ((16Ts)(300000000))/2=78 m, which represents the distance between the UE and the base station's antenna. Similarly, the maximum possible value of T_{A} (1282) corresponds to a UE that is meant to be 99996 m (˜100 Km) away from the base station's antenna at the moment of sending MSGI or the random access preamble.

Once the RRC connection has been established, the TA can be any value from 0 to 63 as indicated by the 6-bit timing advance command, which is carried on the MAC layer using the Physical Downlink Share Channel (PDSCH). Moreover, in this case the timing advance values correspond to adjustments in the distance with respect to the last timing advance command, rather than a total distance between the UE and the cell. For this reason, whenever the eNB identifies that the distance between the UE and eNB significantly changes, the eNB sends the UE an updated TA which indicates a new amount of the time alignment as follows:

N_{TA,new}=N_{TA,old}+(T_{A}−31)*16.

Here, adjustment of the TA value, N_{TA}, by a positive or a negative amount indicates advancing or delaying, respectively, the uplink transmission timing by a given amount of time.

The validity of the assigned TA value is typically determined by the TAT (Time Alignment Timer), which is set by the network. If the TAT expires (this happens when there's no UL and/or DL transmission for a while), the previously assigned TA value is not valid anymore. In such cases, if the UE is still in connected mode, and there is DL data, then the eNB performs a PDCCH order for the PRACH to assign a new TA value to the UE, or if there is UL data, the UE performs the PRACH first to obtain a new TA value, prior to the UL data transmission. The TAT value is received in System Information Block 2 (SIB-2), which is common to all UE's and which is used when a UF, moves from idle to connected mode, or the TAT is set in the macMainConfig as a UE specific value.

However, obtaining a new TA value incurs overhead signalling exchange costs. According to one solution, such overhead may be reduced in small cells (e.g., cells with radius of less than 700 meters, assuming a normal cyclic prefix (CP) is configured) by permitting UEs in such cells to perform idle mode UL transmissions (e.g. as part of MSG 1) without updating a previously configured TA value. Under such conditions, the timing error is expected to be within the range of the cyclic prefix and can therefore be tolerated. However, since cells overlap in irregular patterns, a number of UEs in the cell may have TA values that exceed such tolerance limits. Accordingly, when UEs at or beyond the intended cell radius perform idle mode UL data transmissions using a previously configured TA value UL orthogonality may not be maintained and UL system performance may be significantly degraded.

Certain aspects of the present disclosure and their embodiments may provide solutions to these or other challenges. There are, proposed herein, various embodiments which address one or more of the issues disclosed herein. By re-using existing timing procedures associated with configuration of the TA value (i.e., RACH and once RRC connection has been established), embodiments of the invention facilitate determining the validity of a previously acquired TA value based on the cell radius and/or a history of TA value updates. Certain embodiments may provide one or more technical advantages, such as reducing signalling exchange or overhead and maintaining uplink orthogonality during UL data transmissions.

### SUMMARY

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

According to embodiments of the invention, TA value validity may be maintained when a wireless device is performing an idle mode UL data transmission without unnecessary overhead signalling. A TA value may be considered valid if it is sufficiently accurate or correct to ensure an UL transmission arrives at the correct or expected time at the base station. As explained in the background, the validity of a TA value is typically ensured by a TAT. In addition, or instead of a TAT, a signal strength threshold may be used to trigger a TA update. However, to avoid timing advance errors, the TAT is typically se to a relatively short value that is predetermined or relatively unadaptable, which may result in a stationary or semi-stationary UE updating its TA value very frequently. Moreover, as to signal strength threshold triggers, a signal strength measurement may be unreliable, particularly for UEs near a cell edge. Thus, there is a need for improved methods for determining or maintaining TA value validity.

According to a first general embodiment of the invention, described in greater detail below, the TA validity is determined by comparing a previously configured TA value to a threshold. The threshold may be based on an amount of time required for a radio signal to traverse a distance corresponding to the intended radius of the serving cell. According to a second general embodiment, described in greater detail below and which may be used in combination with or independent of the first embodiment, the TA validity is determined based on a history of TA updates. Moreover, according to a third general embodiment, described in greater detail below and which may be used in combination with one or both of the first and second general embodiments, a previously configured TA value is gradually ramped up or down until the wireless device receives an acknowledgment of successful receipt of the UL data transmission by the base station. Each of the first, second, and third general embodiments may be combined in various ways and may include additional features, as described herein, resulting in multiple specific embodiments.

According to a first aspect of the invention, embodiments of a method of operation of a wireless device in a wireless communication network are disclosed. In some embodiments, a method of operation of a wireless device comprises determining whether a timing advance value previously configured in the wireless device is valid and transmitting uplink data in idle mode to a base station using the previously configured timing advance value at least partially in response to a determination that the previously configured timing advance value is valid. Determining whether the previously configured timing advance value is valid comprises one or both of: 1) comparing the previously configured timing advance value or a function thereof to a validity threshold, wherein the previously configured timing advance value is valid if the previously configured timing advance value or a function thereof is less than the validity threshold, the validity threshold being based on a radius of a cell serving the wireless device, and/or 2) determining if a timing advance validity time period has elapsed, wherein the timing advance validity time period is dependent on a history of timing advance updates for the wireless device.

In some embodiments according to the first aspect of the invention, the history of timing advance updates includes a count of timing advance value updates over a threshold period of time, and the validity time period is related to the count by an inverse relationship. In some embodiments, the history of timing advance updates includes an indication of whether, over a predetermined amount of time, a positive or negative change in the timing advance value exceeds a threshold amount. Moreover, if the threshold amount is not exceeded over the predetermined amount of time, the validity time period used to determine whether the timing advance value previously configured in the wireless device is valid may be set to a first validity time (e.g., infinity), and if the threshold amount is exceeded over the predetermined amount of time, the validity time period may be set to a second validity time, the second validity time being shorter than the first validity time.

In some embodiments according to the first aspect of the invention, the history of timing advance updates includes a count of a number of times a positive or negative change in the timing advance value exceeds a threshold amount over a predetermined amount of time. Moreover, if the count does not exceed a threshold level, the validity time period used to determine whether the timing advance value previously configured in the wireless device is valid is set to a first validity time (e.g., infinity), and if the count does exceed the threshold level, the validity time period is set to a second validity time, the second validity time being shorter than the first validity time.

In some embodiments according to the first aspect of the invention, the method includes receiving a message indicating that the wireless device is allowed to transmit uplink data in idle mode, the transmission of uplink data in idle mode being performed at least partially in response to receipt of the message. In some embodiments, the message indicating that the wireless device is allowed to transmit uplink data in an idle mode includes a flag in a System Information Block (SIB).

In some embodiments according to the first aspect of the invention, the determining of whether a timing advance value previously configured in the wireless device is valid further comprises: determining whether a predetermined time period has elapsed since the previously configured timing advance value was configured, and/or comparing a signal strength value to a threshold.

In some embodiments according to the first aspect of the invention, the method also includes determining whether an acknowledgement of receipt of the uplink data is received from the radio access node; and if the acknowledgement of receipt is not received, reattempting to transmit the uplink data using an adjusted timing advance value. In some embodiments, the reattempting may be performed to a predetermined number of times until the acknowledgement is received and with each repetition the timing advance value is gradually adjusted up or down.

In some embodiments according to the first aspect of the invention, the uplink data transmitted to the base station includes user data received from a user of the wireless device to be forwarded to a host computer via the base station.

According to a second aspect of the invention, embodiments of a method of operating a base station in a wireless communication network are also disclosed. In some embodiments according to the second aspect, a method of operating a base station includes determining a timing advance validity time period for a timing advance value used by a wireless device for uplink data transmissions; and transmitting a message indicating the determined timing advance validity time period to the wireless device. The timing advance validity time period may be determined in dependence on a history of timing advance updates for the wireless device.

In some embodiments according to the second aspect of the invention, the method further includes transmitting a message indicating that the wireless device is allowed to transmit uplink data in idle mode.

In some embodiments according to the second aspect of the invention, the history of timing advance updates includes a count of timing advance value updates over a threshold period of time, and the validity time period is related to the count by an inverse relationship.

In some embodiments according to the second aspect of the invention, the history of timing advance updates includes an indication of whether a positive or negative change in the timing advance value exceeds a threshold amount. Moreover, if the threshold amount is not exceeded for a predetermined amount of time the validity time period used to determine whether the timing advance value previously configured in the wireless device is valid is set to a long term validity time, and if the threshold amount is exceeded during the predetermined amount of time the validity time period is set to a short term validity time, the short term validity time being shorter than the long term validity time.

In some embodiments according to the second aspect, a second method of operating a base station includes determining a validity threshold for evaluating whether a timing advance value configured in a wireless device is valid, the validity threshold being based on a radius of a cell served by the base station; and transmitting a message indicating the validity threshold to one or more wireless devices in the cell.

In some embodiments according to the second aspect, the second method of operating a base station includes transmitting a message indicating that the wireless device is allowed to transmit uplink data in idle mode.

According to a third aspect of the invention, embodiments of a wireless device operable in a wireless communication network are also disclosed. The wireless device may include processing circuitry configured to perform any of the steps of any of the embodiments described above according to the first aspect of the invention. The wireless device may further include power supply circuitry configured to supply power to the wireless device.

According to a fourth aspect of the invention, embodiments of a base station operable in a wireless communication network are also disclosed. The base station may include processing circuitry configured to perform any of the steps of any of the embodiments described above according to the second aspect of the invention. The wireless device may further include power supply circuitry configured to supply power to the base station.

According to a fifth aspect of the invention, embodiments of a user equipment (UE) operable in a wireless communication network are also disclosed, The UE can be configured to perform particular operations or actions by virtue of having software, firmware, hardware, or a combination of them installed on the UE that in operation causes or cause the UE to perform the actions. One or more computer programs can be configured to perform particular operations or actions by virtue of including instructions that, when executed by data processing apparatus, cause the apparatus to perform the actions. In some embodiments according to the fifth aspect of the invention, the UE includes an antenna configured to send and receive wireless signals. The UE also includes radio front-end circuitry connected to the antenna and to processing circuitry, and configured to condition signals communicated between the antenna and the processing circuitry. The antenna also includes the processing circuitry being configured to perform any of the steps of any of the methods described above according to the first aspect of the invention. The UE also includes an input interface connected to the processing circuitry and configured to allow input of information into the UE to be processed by the processing circuitry. The UE also includes an output interface connected to the processing circuitry and configured to output information from the UE, that has been processed by the processing circuitry. The UE also includes a battery connected to the processing circuitry and configured to supply power to the UE. Other embodiments of this aspect include corresponding computer systems, apparatus, and computer programs recorded on one or more computer storage devices, each configured to perform the actions of the methods.

According to a sixth aspect of the invention, embodiments of a communication system are enclosed. In some embodiments, the communication system including a host computer includes: processing circuitry configured to provide user data; and a communication interface configured to forward the user data to a cellular network for transmission to a UE, where the cellular network includes a base station having a radio interface and processing circuitry, the base station's processing circuitry configured to perform any of the steps of any of the methods described above according to the second aspect of the invention. Other embodiments of this aspect include corresponding computer systems, apparatus, and computer programs recorded on one or more computer storage devices, each configured to perform the actions of the methods.

In some embodiments according to the sixth aspect of the invention, the communication system includes the base station and/or the UE, where the UE is configured to communicate with the base station.

In some embodiments according to the sixth aspect of the invention, the processing circuitry of the host computer is configured to execute a host application, thereby providing the user data; and the UE includes processing circuitry configured to execute a client application associated with the host application.

According to a seventh aspect of the invention, embodiments of a method implemented in a communication system including a host computer, a base station and a UE are disclosed. In some embodiments according to the seventh aspect of the invention, the method includes: at the host computer, providing user data; and at the host computer, initiating a transmission carrying the user data to the UE via a cellular network including the base station, where the base station performs any of the methods described above according to the second aspect of the invention. The method may further include further include transmitting the user data from the base station.

Certain embodiments of the present disclosure may provide one or more technical advantages. For example, a technical advantage of certain embodiments may be less delay in determining validity of a previously acquired TA value, which enhances system performance by, e.g., reducing latency, improving transmission speeds, improving capacity, reducing power use, and/or improving efficiency of bandwidth use. Moreover, certain embodiments may provide one or more other technical advantages, such as reducing signalling exchange or overhead and maintaining uplink orthogonality during UL data transmissions. Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates a wireless network in accordance with some embodiments;

FIG. 2 illustrates an example User Equipment (UE) in accordance with some embodiments;

FIG. 3 is illustrates a virtualization environment in accordance with some embodiments;

FIG. 4 is illustrates an example telecommunications network connected via an intermediate network to a host computer in accordance with some embodiments;

FIG. 5 illustrates an example host computer communicating via a base station with a user equipment over a partially wireless connection in accordance with some embodiments;

FIG. 6 is a flow diagram of an example method implemented in a communication system including a host computer, a base station and a user equipment in accordance with some embodiments;

FIG. 7 is a flow diagram of another example method implemented in a communication system including a host computer, a base station and a user equipment in accordance with some embodiments;

FIG. 8 is a flow diagram of a first method for use in a wireless device, in accordance with certain embodiments;;

FIG. 9 is a flow diagram of a second method for use in a base station, in accordance with certain embodiments;

FIG. 10 is a flow diagram of a third method for use in a base station, in accordance with certain embodiments; and.

FIG. 11 is a block diagram illustrating examples of modules that may be included in the example base station or the example wireless device, in accordance with certain embodiments.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Wireless Device: As used herein, a “wireless device” is any type of device that has access to (i.e., is served by) a cellular communications network by wirelessly transmitting and/or receiving signals to a radio access node(s). Some examples of a wireless device include, but are not limited to, a User Equipment device (UE) in a 3GPP network and a Machine Type Communication (MTC) device.

Base Station: As used herein, a “base station” is sometimes referred to as a “network node” and is any node in a radio access network of a cellular communications network that operates to wirelessly transmit and/or receive signals. Some examples of a radio access node include, but are not limited to, an enhanced or evolved Node B (eNB) in a Third Generation Partnership Project (3GPP) Long Term Evolution (LTE) network, a gNode B (gNB) in a 3GPP New Radio (NR) network, a high-power or macro base station, a low-power base station (e.g., a micro base station, a pica base station, a home eNB, or the like), and a relay node.

Note that the description given herein focuses on a 3GPP cellular communications system and, as such, 3GPP NR terminology or terminology similar to 3GPP NR terminology is oftentimes used. However, the concepts disclosed herein are not limited to NR or a 3GPP system.

### First General Embodiment

An eNB (or other type of base station) can tolerate an overall uplink timing error that is in the range of the cyclic prefix used in the transmission of the LTE-M and NB-IoT uplink channels. The LTE normal cyclic prefix, typically used, has a length of 4.7 us, which implies that a wireless device can at least expect to receive an updated TA configuration after moving ˜700 meters closer to or away from its serving eNB. 3GPP specifications for LTE also support an extended cyclic prefix, which is less prone to uplink timing errors at the cost of an increased overhead. The amount of timing error tolerance provided by the cyclic prefix along with knowing the intended cell's radius can be used to determine the validity of a TA value.

When in idle mode the UE intends to transmit UL data (whether the UL data be user plane data or RRC signaling, such as an RRC setup message), there needs to be a way of knowing whether the TA value it currently holds is appropriate to proceed with transmission of the uplink data. To this end, when a UE within a cell having a given cell radius is allowed by the network (e.g., via a System Information flag) to perform an idle mode data transmission, the UE(s) that can proceed to transmit data is/are only the one(s) having a TA value corresponding to a distance that is less than (or, in some embodiments, less than or equal to) the intended cell radius. Cells in which such idle mode transmission are allowed may be restricted to cells having a relatively small radius, i.e., a radius that is smaller than a limit afforded by the cyclic prefix length (e.g., 700 meters, in the case of a normal, non-extended cyclic prefix).

More specifically, for a cell's radius of Y meters and recalling that the TA value is obtained from a range of TA values which are associated with a distance between the UE and the cell's antenna, a UE, according to one embodiment, may determine that an idle mode data transmission is permissible if: 1) a flag has been set to indicate the UE that it is allowed to perform a data transmission; and 2) the TA value that the UE currently holds is less than X, where X=floor(Y/((16Tₛc)/2)), and c is the speed of light or ˜300 000 000 m/s. Determining the value of the threshold X, can also be simply expressed as the cell's radius over 1 step T_{A} (i.e., Y/((16Tₛc)/2)), or using any other rounding operation (e.g., ceil(Y/((16Tₛc)/2))).

In one embodiment, the threshold X may be indicated (e.g., communicated directly or derived from a parameter that is communicated directly) by a configuration message received from a base station. Moreover, in certain embodiments the threshold may be a distance threshold rather than a time threshold. For example, the threshold may be Y and the TA value being compared to the threshold may be converted to a distance, e.g., by multiplying the TA value by (16Tₛc)/2, prior to the comparison.

For example, in the case of a small cell deployment, when a normal cyclic prefix has been configured (i.e., CP length 4.7 us) and the cell radius happens to be ˜700 meters. The eventual transmission of uplink data in idle mode will depend on:
1. That the flag allowing the UE to perform an uplink data transmission is set (e.g., it might be a SIB flag).
2. From knowing that Y=700 meters, and after having determined that X=floor(Y/((16Tₛc)/2))=floor(700/78)=8, the UE can determine that the TA value that the UE currently holds is valid and proceed to transmit uplink data if the TA value is less than 8 (e.g., recall that after the RRC connection has been established, the TA can be any value from 0 to 63). Otherwise the UE or network may consider the TA value to be incorrect or outdated and UE will not transmit the uplink data even if the flag in step 1 is set. Accordingly, UEs located near the cell edge on spotty coverage areas will not perform UL data transmissions with outdated/incorrect TA values.

### Second General Embodiment

As discussed in the background section, in RRC connected mode the eNB can update the TA values when the eNB identifies that the distance between the eNB and UE changes. Notice that the TA value only depends on the distance between eNB (antenna) and the UE (antenna). Therefore, for a (semi)-stationary UE, the same TA value can be applied for all the UL data transmissions and no TA update is needed, as long as the position of the UE remains approximately the same.

One difficulty with assigning the UE a TA value with long validity is that it is difficult to determine whether a UE is stationary or not. Certainly, it is possible to include whether the UE is stationary or not in the subscription information, However, such information is deemed to be not reliable due to several reasons. For example, the purpose of the device may not be determined until it is activated, or the device may be repurposed after activation without informing the operator. Moreover, there are more complicated scenarios where the devices are stationary for some time only or restricted to move in a given area. For example, in goods tracking, the devices can remain in the same location for hours or even days before it moves again, but the device still needs to report its position to the owner(s). Another example is that, a device only moves in a given area, e.g., assets or patient tracking. Therefore, the eNB or network cannot only depend on the subscription information to assign a TA with long validity to a UE, especially for the UE that uses this TA value in idle mode.

In one embodiment, a determination is made as to whether a UE is (semi-)stationary or not based on its previous behaviors (either in connected mode or idle mode). To be more specific, the eNB and/or network and/or UE can keep track of previous TA values assigned to a particular UE. And based on the how often the TA values need to be updated and/or the range of the updated TA values, the eNB or network can determine whether the UE is a mobile UE or (semi-)stationary. This information can then be used together with other information, e.g., subscription data, for the eNB to determine whether to allow the UE to apply a previously configured TA value directly next time when the UE intends to send UL data in idle or connected mode without acquiring a new one. The UL data may be user plane data or RRC signaling, such as an RRC setup message.

For example, according to one embodiment, if the TA value that the eNB estimated and assigned to a UE has not been changed for a predetermined time (e.g, can be tens of minutes, several hours or even several days), the eNB and/or network can (temporally) identifies the UE as a (semi-)stationary UE, and assign it a TA value with long term validity time (the validity time of the TA value can be signaled to the UE or predetermined). However, the UE may still be required to verify, e.g., based on system information or signal quality, that the assigned TA value is valid before deciding whether to apply the assigned TA value or not in the next UL transmission. If all criteria for applying the assigned or existing TA value are fulfilled, then the UE directly applies the assigned TA value without asking for a new one when initializing its UL transmissions.

According to another example embodiment, a UE may be identified as (semi-)stationary or having limited mobility if the TA values that the eNB estimates and assigns to a UE change over a predetermined period of time, but the changes are always within a range (e.g., +/−N_{TA}) or do not go outside the range more than a threshold number of times during the predetermined period of time. Such conditions may be taken to imply that the UE has very limited mobility, e.g., it cannot move out from a given area. In this case, even if the UE does not identify itself as a (semi-)stationary UE, e.g. from the subscription information, the eNB and/or network, can still, based on long term observation, identify the UE as a semi-)stationary UE or UE with limited mobility. In this case, the eNB and or network can assign the UE with a proper TA value with a long validity time (the validity time of the TA can be signaled to the UE). However, the UE may still be required to verify, e.g., based on system information or signal quality, that the assigned TA value is valid before deciding whether to apply the assigned TA value or not in the next UI, transmission. If all criteria for applying the assigned or existing TA value are fulfilled, then the UE directly applies the assigned TA value without asking for a new one when initializing its UL transmissions.

In some embodiments the assigned TA value can be UE specific, i.e., included in the RRC messages. Or, in further embodiments, the assigned TA value can be cell specific, i.e., the eNB or network only allows a UE at some given distance away (e.g., about 700 meters) to use this function of long term TA value validity time. Or, in yet further embodiments, the cell can support several predefined TA values (e.g., broadcast in system information), and the eNB or network assigns these values to different UEs.

### Third General Embodiment

A third embodiment may be implemented in combination with one or both of the first or second general embodiments described above. According to the third embodiment, in case the UE does not receive a response from the base station acknowledging the successful reception of the idle mode data transmission, the UE may increment its initial TA value TA_{INIT} by a configured value dTA. Then reattempt the idle mode data transmission using TA value TA_{INIT}+dTA. After N unsuccessful attempts the UE will make use of TA value TA_{INIT}+N×dTA.

As an alternative the UE may decrement the initial TA value TA_{INIT} by a configured value dTA. Then reattempt the idle mode data transmission using TA value TA_{INIT}−dTA. After N unsuccessful attempts the UE will make use of TA value TA_{INIT}−N×dTA.

### Additional Embodiments

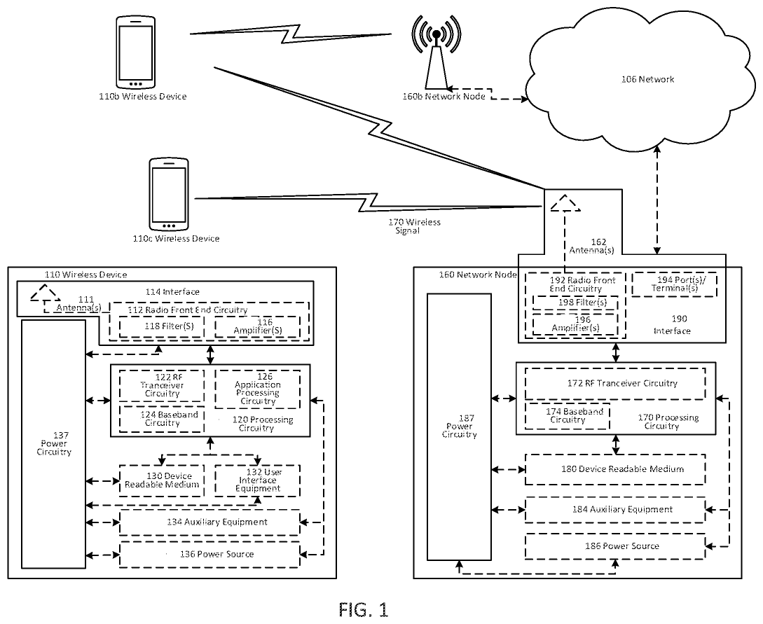

Although the subject matter described herein may be implemented in any appropriate type of system using any suitable components, the embodiments disclosed herein are described in relation to a wireless network, such as the example wireless network illustrated in FIG. 1. For simplicity, the wireless network of FIG. 1 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WAN), local area networks (LANs), wireless local area networks (WLANs), wired networks, wireless networks, metropolitan area networks, and other networks to enable communication between devices.

Network node 160 and WD 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node (alternately referred to as base station) refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes or base stations include, but are not limited to, access points (APs) (e.g., radio access points), base stations (BSs) (e.g , radio base stations, Node Bs, evolved Node Bs (eNBs) and NR NodeBs (gNBs)). Base stations may be categorized based on the amount of coverage they provide (or, stated. differently, their transmit power level) and may then also be referred to as femto base stations, pica base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated. radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 1, network node 160 includes processing circuitry 170, device readable medium 180, interface 190, auxiliary equipment 184, power source 186, power circuitry 187, and antenna 162. Although network node 160 illustrated in the example wireless network of FIG. 1 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components, In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination,

Processing circuity 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160, but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by, radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 190 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 1 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WID may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LIVIE), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band interact of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 114 is connected to antenna 111 and processing circuitry 120, and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing. circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110 as a whole, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction mar be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into WD 110, and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network, and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry. Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

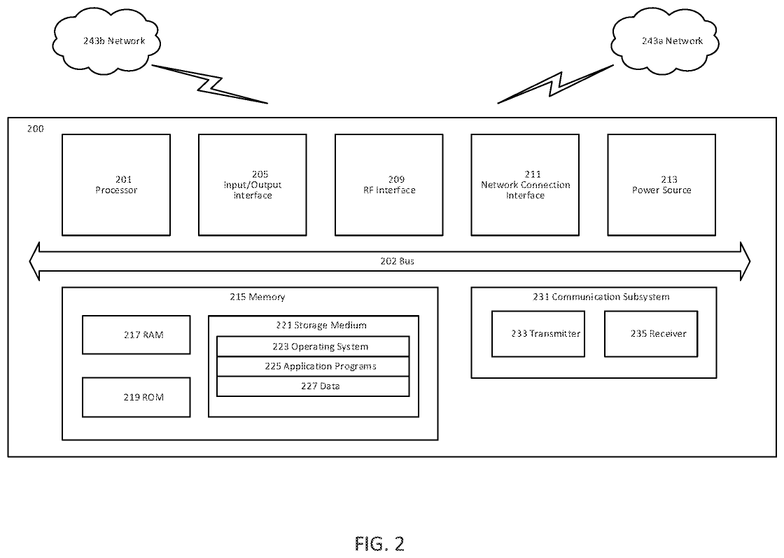

FIG. 2 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 2200 may be any UE identified by the 3rd Generation Partnership Project (3GPP), including a NB-IoT UE, a machine type communication (MTC) UE, and/or an enhanced MTC (eMTC) UE. UE 200, as illustrated in FIG. 2, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 2 is a UE, the components discussed herein are equally applicable to a WD, and vice-versa.

In FIG. 2, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may utilize all of the components shown in FIG. 2, or only a subset of the components. The level of integration between the components may vary from one UE to another UE. Further, certain UEs may contain multiple instances of a component, such as multiple processors, memories, transceivers, transmitters, receivers, etc.

In FIG. 2, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, optical sensor.

In FIG. 2, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver arid transmitter functionality appropriate to the communication network links (e,g., optical, electrical, and the like), The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 2, processing circuitry 201 may be configured to communicate with network 243b using communication subsystem 231. Network 243a and network 243b may be the same network or networks or different network or networks.

Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like), Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. in another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

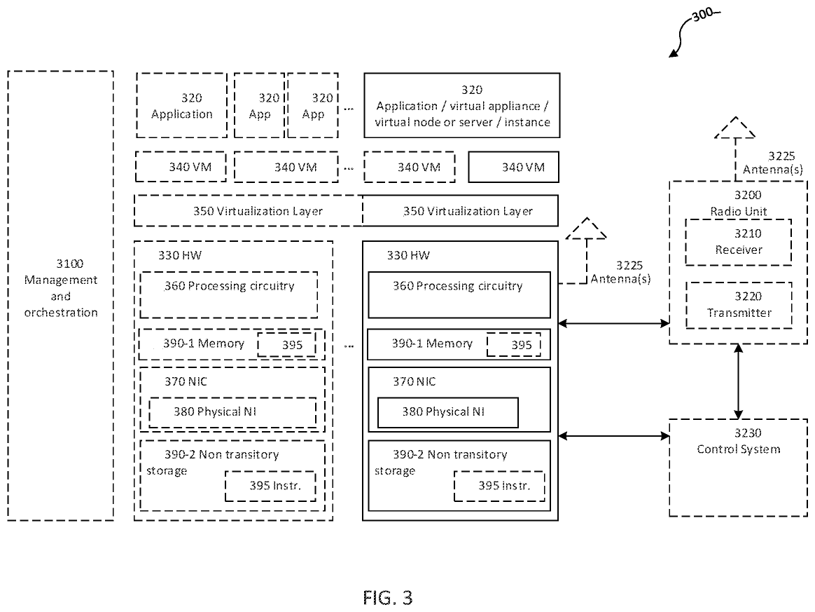

FIG. 3 is a schematic block diagram illustrating a virtualization environment 300 in which functions implemented. by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may he non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 3, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 3.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signalling can be effected with the use of control system 3230 which may alternatively be used for communication between the hardware nodes 330 and radio units 3200.

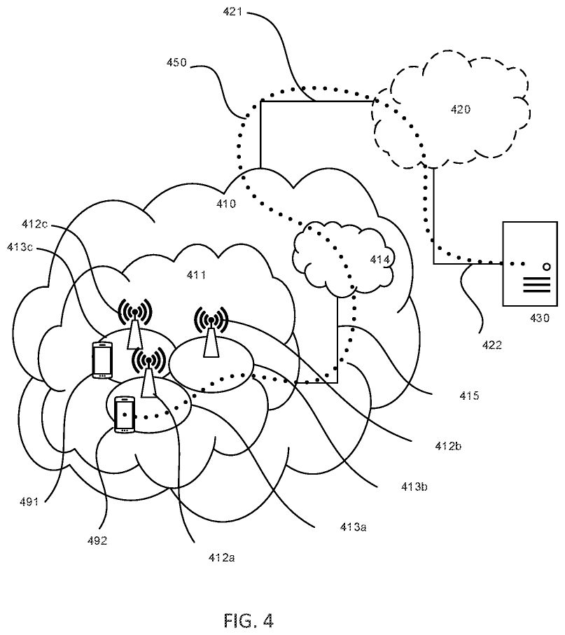

With reference to FIG. 4, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412h, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 4 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

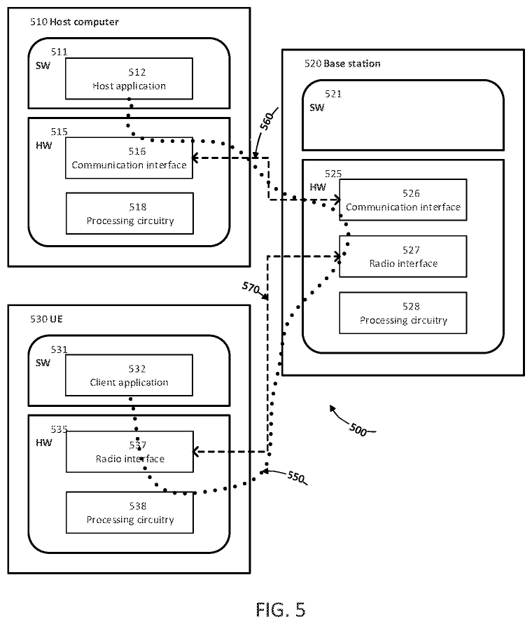

Example implementations, in accordance with an embodiment of the UE, base station and host computer discussed in the preceding paragraphs, will now be described with reference to FIG. 5. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 5) served by base station 520. Communication interface 526 may be configured to facilitate connection 560 to host computer 510. Connection 560 may be direct or it may pass through a core network (not shown in FIG. 5) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 5 may be similar or identical to host computer 430, one of base stations 412a, 412b, 412c and one of UEs 491, 492 of FIG. 4, respectively. This is to say, the inner workings of these entities may be as shown in FIG. 5 and independently, the surrounding network topology may be that of FIG. 4.

In FIG. 5, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may reduce signaling overhead and maintain UL performance and thereby provide benefits such as extended battery life and increased network capacity.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art, In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

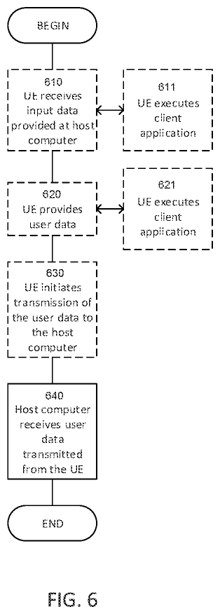

FIG. 6 is a flowchart illustrating a method implemented in a communication system, in accordance with one embodiment. The communication system includes a host computer, a base station and a UF, which may be those described with reference to FIGS. 4 and 5. For simplicity of the present disclosure, only drawing references to FIG. 6 will be included in this section. In step 610 (which may be optional), the LE receives input data. provided by the host computer. Additionally or alternatively, in step 620, the UE provides user data. In substep 621 (which may be optional) of step 620, the UE provides the user data by executing a client application. In substep 611 (which may be optional) of step 610, the UE executes a client application which provides the user data in reaction to the received input data provided by the host computer. in providing the user data, the executed client application may further consider user input received from the user. Regardless of the specific manner in which the user data was provided, the UE initiates, in substep 630 (which may be optional), transmission of the user data to the host computer. In step 640 of the method, the host computer receives the user data transmitted from the UE, in accordance with the teachings of the embodiments described throughout this disclosure.

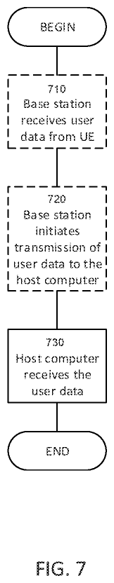

FIG. 7 is a flowchart illustrating a method implemented in a communication system, in accordance with one embodiment. The communication system includes a host computer, a base station and a UE which may be those described with reference to FIGS. 4 and 5. For simplicity of the present disclosure, only drawing references to FIG. 7 will be included in this section. In step 710 (which may be optional), in accordance with the teachings of the embodiments described throughout this disclosure, the base station receives user data from the UE. In step 720 (which may be optional), the base station initiates transmission of the received user data to the host computer. In step 730 (which may be optional), the host computer receives the user data carried in the transmission initiated by the base station.

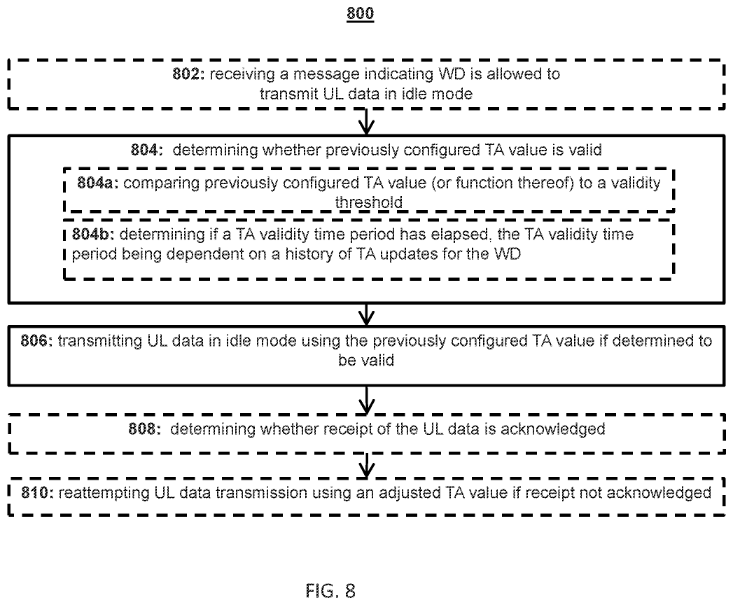

FIG. 8 depicts a method in accordance with particular embodiments. The method includes step 804, in which a previously configured or acquired TA value in a wireless device is evaluated to determine whether it is valid, The determination may include one or both of the following sub-steps: 804a) comparing the previously configured TA value or a function thereof to a validity threshold, and/or 804b) determining if a TA validity time period has elapsed. As to the first sub-step, the validity threshold may be based on a radius of a cell serving the wireless device and if the previously configured TA value (or a function thereof) is less than the validity threshold, the previously configured TA value is determined to be valid. Moreover, as to the second sub-step, the TA validity time period may be dependent on a history of timing advance updates for the wireless device. In certain embodiments, the first sub-step is only applied in cells having a cell radius below a threshold radius. For example, if the cell radius is the same or smaller than a distance traversed by a radio signal with the duration of a cyclic prefix, a TA error experienced by a wireless device in such a cell will likely not exceed a tolerance permitted by the cyclic prefix, whereas for larger cells the TA error will have a higher likelihood of exceeding the tolerance. However, to avoid the possibility of TA errors even in small cells, wireless devices with previously configured TA values that correspond to a position at the edge of the cell may be prevented, by the first sub-step, from using their previously configured TA values by comparing their previously configured TA value (or function thereof) to a radius-based threshold.

The method of FIG. 8 also includes step 806, in which uplink data is transmitted in idle mode to a base station using the previously configured timing advance value if the previously configured timing advance value is determined to be valid. The method also may include optional step 802, in which a message is received by the wireless device indicating that the wireless device is allowed to transmit uplink data in idle mode. In one embodiment, the message may include a flag in a System Information Block (SIB). Moreover, the transmission of uplink data in step 806 may be performed at least partially in response to receipt of the message granting permission to transmit uplink data in idle mode.

The determination of whether the previously configured TA value is valid may include evaluation of additional criteria, as well. For example, the criteria may include whether a predetermined time period (e.g., 24 hours) has elapsed since the previously configured timing advance value was configured, and/or whether a signal strength value (e.g., an RSRP or RSRQ measurement) exceeds a threshold.

In one embodiment, the history of timing advance updates includes a count of timing advance value updates over a threshold period of time, and wherein the validity time period is related to the count by an inverse relationship. For example, if the count is high (e.g., above a threshold) the validity time period is set to a low value and if the count is low (e.g., below a threshold), the validity time period is set to a high value. In some embodiments the count may be compared to multiple different threshold levels (e.g., low, medium, high), corresponding to multiple different validity time periods (e.g., high, medium, low).

In another embodiment, the history of timing advance updates includes an indication of whether, over a predetermined amount of time, a positive or negative change in the timing advance value exceeds a threshold amount. If the threshold amount is not exceeded over the predetermined amount of time, the validity time period is set to a long validity time and if the threshold amount is exceeded over the predetermined amount of time, the validity time period is se to a short validity time, in another embodiment, the history of timing advance updates includes a count of a number of times a positive or negative change in the timing advance value exceeds a threshold amount over a predetermined amount of time, If the count does not exceed a threshold level, the validity time period is set to a long validity time and if the count does exceed the threshold level, the validity time period is set to a short validity time.

The method of FIG. 8 also may include optional steps 808 and 810, in which a TA value is ramped or adjusted gradually up and/or down if receipt of the uplink data is not acknowledged, For example, the TA value may be repeatedly ramped up and then ramped down, or vice-versa, when receipt is repeatedly not acknowledged. The transmission reattempts may be repeated a predetermined number of times before the previously configured TA value is determined to be invalid and a TA value update is performed.

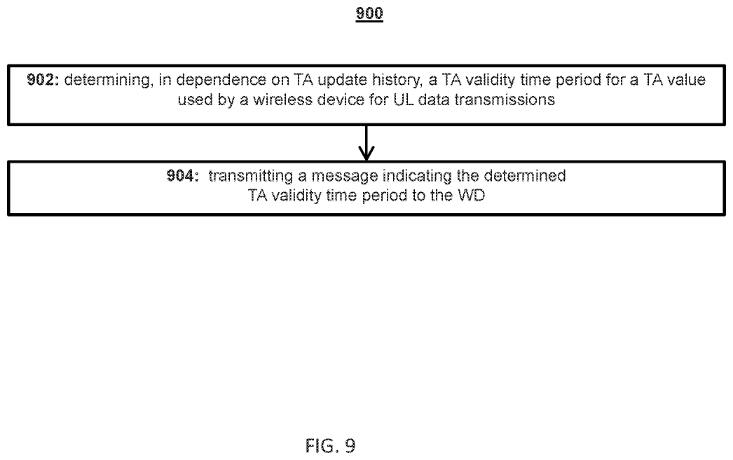

FIG. 9 depicts another method in accordance with particular embodiments. The method includes step 902, in which a timing advance validity time period for a timing advance value used by a wireless device for uplink data transmissions is determined. The determination is made in dependence on a history of timing advance updates for the wireless device. The history may be tracked by the base station, the wireless device, or both. The method also includes step 904, in which a message is transmitted to the wireless device, the message indicating the determined timing advance validity time period. The message may be included in a control information channel message as a parameter or field in an information element, for example.

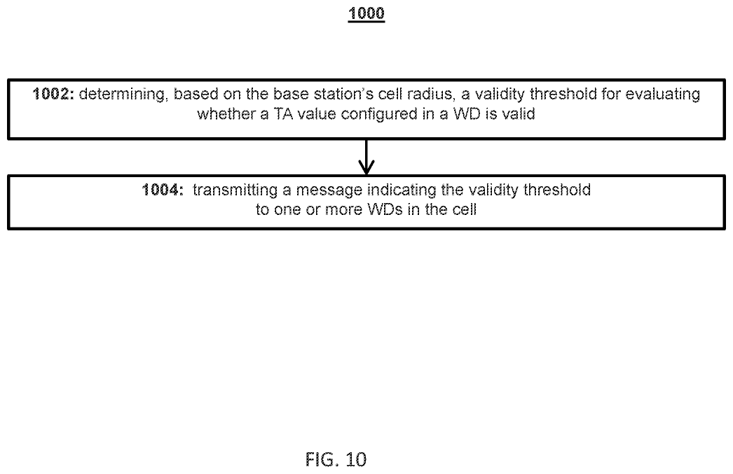

FIG. 10 depicts another method in accordance with particular embodiments. The method includes step 1002, in which a validity threshold is determined, the validity threshold being a threshold for evaluating whether a timing advance value configured in a wireless device is valid determined. The validity threshold may be based on the base station's cell radius. The method also includes step 1004, in which a message is transmitted to the wireless device, the message indicating the determined validity threshold, which the wireless device may use to determine whether a previously configured TA value is valid. The message may be included in a control information channel message as a parameter or field in an information element, for example.

The methods of FIGS. 9 and 10 may include additional steps as well. For example, each of the methods may include transmitting a message indicating that the wireless device is allowed to transmit uplink data in idle mode.

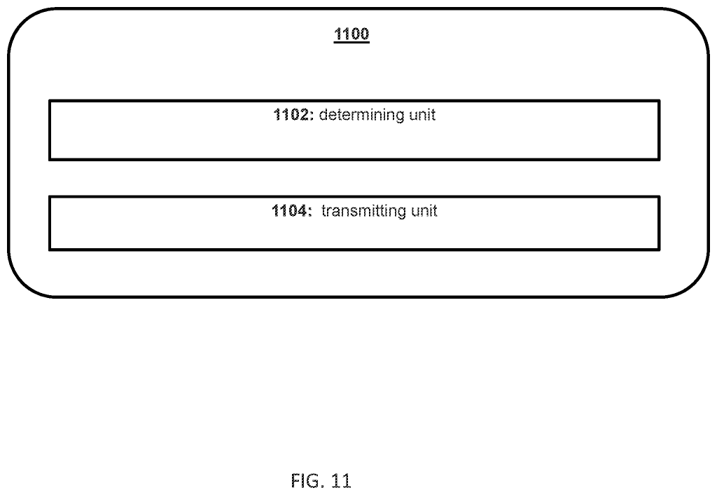

FIG. 11 illustrates a schematic block diagram of an apparatus 1100 in a wireless network (for example, the wireless network shown in FIG. 1). The apparatus may be implemented in a wireless device or network node (e.g., wireless device 110 or network node 160 shown in FIG. 1). Apparatus 1100 is operable to carry out the example method described with reference to FIG. 8 and possibly any other processes or methods disclosed herein. It is also to be understood that the method of FIG. 8 is not necessarily carried out solely by apparatus 1100. At least some operations of the method can be performed by one or more other entities.

Virtual Apparatus 1100 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause determining unit 1102 and transmitting unit 1104 and any other suitable units of apparatus 110 to perform corresponding functions according one or more embodiments of the present disclosure.

As illustrated in FIG. 11, apparatus 1100 includes determining unit 1102 and transmitting unit 1104. Determining unit 1102 is configured to determine whether a previously configured TA value in a wireless device is valid. The determination may include one or both of the following sub-steps: 1) comparing the previously configured TA value or a function thereof to a validity threshold that is based on a radius of the serving cell, and/or 2) determining if a TA validity time period has elapsed, the timing advance validity time period being dependent on a history of timing advance updates for the wireless device. Transmitting unit 1104 is configured to transmit uplink data in idle mode to a base station using the previously configured timing advance value if the previously configured timing advance value is valid.

Alternatively, apparatus 1100 is operable to carry out one or both of the example methods described with reference to FIGS. 9 and 10. Thus, in correspondence to the method of FIG. 9, the determining unit 1102 may be configured to determine a timing advance validity time period for a timing advance value used by a wireless device for uplink data transmissions. Moreover, the transmitting unit 1104 may be configured to transmit a message indicating the determined timing advance validity time period to the wireless device. Alternatively, with reference to the method of FIG. 10, the determining unit 1102 may be configured to determine a validity threshold for evaluating whether a timing advance value configured in a wireless device is valid, the validity threshold being based on the base station's cell radius. In addition, transmitting unit 1104 may be configured to transmit a message indicating the determined validity threshold to the wireless device. The wireless device may then use the validity threshold to determine whether a previously configured TA value is valid.

The methods of FIGS. 9 and 10 are not necessarily carried out solely by apparatus 1100. At least some operations of the method can be performed by one or more other entities. Furthermore, the term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).

| Abbreviation | Explanation |
|---|---|
| SC-FDMA | Single Carrier Frequency Division Multiple Access |
| LTE-M | Long Term Evolution for Machine Type Communication |
| NB-IoT | Narrowband Internet of Things |
| MSG1 | Message 1 |
| N_{TA} | Timing offset between uplink and downlink radio |
| | frames at the UE, expressed in units of Ts |
| PDSCH | Physical Downlink Share Channel |
| RACH | Random Access Procedure |
| RRC | Radio Resource Control |
| SIB | System Information Block |
| TA | Timing Advance |
| TAT | Time Alignment Timer |
| UE | User Equipment |
| UL | Uplink |

1. A method performed by a wireless device in a wireless communication network, the method comprising:
determining whether a timing advance value previously configured in the wireless device is valid; and
transmitting uplink data in idle mode to a base station using the previously configured timing advance value at least partially in response to a determination that the previously configured timing advance value is valid,
wherein determining whether the previously configured timing advance value is valid comprises one or more of:
comparing the previously configured timing advance value or a function thereof to a validity threshold, wherein the previously configured timing advance value is valid if the previously configured timing advance value or a function thereof is less than the validity threshold, the validity threshold being based on a radius of a cell serving the wireless device, and/or
determining if a timing advance validity time period has elapsed, wherein the timing advance validity time period is dependent on a history of timing advance updates for the wireless device.

2. The method according to claim 1, further comprising:
receiving a message indicating that the wireless device is allowed to transmit uplink data in idle mode,
wherein the transmission of uplink data in idle mode is performed at least partially in response to receipt of the message.

3. The method according to claim 2, wherein the message indicating that the wireless device is allowed to transmit uplink data in an idle mode includes a flag in a System Information Block (SIB).

4. The method according to claim 1, wherein determining whether a timing advance value previously configured in the wireless device is valid further comprises:
determining whether a predetermined time period has elapsed since the previously configured timing advance value was configured, and/or
comparing a signal strength value to a threshold.

5. The method according to claim 1-4, wherein the history of timing advance updates includes a count of timing advance value updates over a threshold period of time, and wherein the validity time period is related to the count by an inverse relationship.

6. The method according to claim 1, wherein the history of timing advance updates includes an indication of whether, over a predetermined amount of time, a positive or negative change in the timing advance value exceeds a threshold amount, wherein:
if the threshold amount is not exceeded over the predetermined amount of time, the validity time period used to determine whether the timing advance value previously configured in the wireless device is valid is set to a first validity time, and if the threshold amount is exceeded over the predetermined amount of time, the validity time period is set to a second validity time, the second validity time being shorter than the first validity time.

7. The method according to claim 1, wherein the history of timing advance updates includes a count of a number of times a positive or negative change in the timing advance value exceeds a threshold amount over a predetermined amount of time, wherein:
if the count does not exceed a threshold level, the validity time period used to determine whether the timing advance value previously configured in the wireless device is valid is set to a first validity time, and
if the count does exceed the threshold level, the validity time period is set to a second validity time, the second validity time being shorter than the first validity time.

8. The method according to claim 1, further comprising:
determining whether an acknowledgement of receipt of the uplink data is received from the radio access node; and
if the acknowledgement of receipt is not received, reattempting to transmit the uplink data using an adjusted timing advance value.

9. The method according to claim 8, further comprising reattempting to transmit the uplink data a predetermined number of times until the acknowledgement is received, wherein with each repetition the timing advance value is gradually adjusted up or down.

10. The method according to claim 1, wherein the uplink data transmitted to the base station includes user data received from a user of the wireless device to be forwarded to a host computer via the base station.

11. A method performed by a base station in a wireless communication network, the method comprising:
determining a timing advance validity time period for a timing advance value used by a wireless device for uplink data transmissions, wherein the timing advance validity time period is determined in dependence on a history of timing advance updates for the wireless device; and
transmitting a message indicating the determined timing advance validity time period to the wireless device.

12. The method according to claim 11, further comprising:
transmitting a message indicating that the wireless device is allowed to transmit uplink data in idle mode.

13. The method according to claim 11, wherein the history of timing advance updates includes a count of timing advance value updates over a threshold period of time, and wherein the validity time period is related to the count by an inverse relationship.

14. The method according to claim 11, wherein the history of timing advance updates includes an indication of whether a positive or negative change in the timing advance value exceeds a threshold amount, wherein:
if the threshold amount is not exceeded for a predetermined amount of time the validity time period used to determine whether the timing advance value previously configured in the wireless device is valid is set to a long term validity time, and
if the threshold amount is exceeded during the predetermined amount of time the validity time period is set to a short term validity time, the short term validity time being shorter than the long term validity time.

15-17. (canceled)

18. A wireless device operable in a wireless communication network, the wireless device comprising:
power supply circuitry configured to supply power to the wireless device; and
processing circuitry configured to:
determine whether a timing advance value previously configured in the wireless device is valid; and
transmit uplink data in idle mode to a base station using the previously configured timing advance value at least partially in response to a determination that the previously configured timing advance value is valid,
wherein to determine whether the previously configured timing advance value is valid, the processing circuitry is further configured to:
compare the previously configured timing advance value or a function thereof to a validity threshold, wherein the previously configured timing advance value is valid if the previously configured timing advance value or a function thereof is less than the validity threshold, the validity threshold being based on a radius of a cell serving the wireless device, and/or
determine if a timing advance validity time period has elapsed, wherein the timing advance validity time period is dependent on a history of timing advance updates for the wireless device.

19. A base station operable in a wireless communication network, the base station comprising:
power supply circuitry configured to supply power to the base station; and
processing circuitry configured to:
determine a timing advance validity time period for a timing advance value used by a wireless device for uplink data transmissions, wherein the timing advance validity time period is determined in dependence on a history of timing advance updates for the wireless device; and
transmit a message indicating the determined timing advance validity time period to the wireless device.

20-23. (canceled)

24. The wireless device according to claim 18, wherein the processing circuitry is further configured to:
receive a message indicating that the wireless device is allowed to transmit uplink data in idle mode,
wherein the transmission of uplink data in idle mode is performed at least partially in response to receipt of the message.

25. The base station according to claim 19, wherein the processing circuitry is further configured to:
transmit a message indicating that the wireless device is allowed to transmit uplink data in idle mode.

26. The base station according to claim 19, wherein the history of timing advance updates includes an indication of whether a positive or negative change in the timing advance value exceeds a threshold amount, wherein:
if the threshold amount is not exceeded for a predetermined amount of time the validity time period used to determine whether the timing advance value previously configured in the wireless device is valid is set to a long term validity time, and
if the threshold amount is exceeded during the predetermined amount of time the validity time period is set to a short term validity time, the short term validity time being shorter than the long term validity time.
